(19) United States
(12) Patent Application Publication
(10) Pub. No.: US 2011/0191675 A1
(43) Pub. Date: Aug. 4, 2011

(54) SLIDING INPUT USER INTERFACE

(75) Inventor: Eero M. J. Kauranen, Salo (FI)

(73) Assignee: NOKIA CORPORATION, Espoo (FI)

(21) Appl. No.: 12/698,016

(22) Filed: Feb. 1, 2010

(51) Int. Cl. G06F 3/041

(52) U.S. Cl. 715/702

(57) ABSTRACT

A method, apparatus, user interface and computer program product for using a device to detect a signal corresponding to a sliding input on a touch sensitive area of the device, the sliding input being for a time setting adjustment. A time unit corresponding to a start point of the sliding input is determined, and if the signal indicates that the sliding input is substantially in a first direction, a time setting of the corresponding time unit is increased by a pre-defined increment, and if the signal indicates that the sliding input is substantially in a second direction, the time setting of the corresponding time unit is decreased by a pre-defined increment. Feedback signals are provided at regular intervals of length, along the route of the sliding movement. Those feedback signals can be sensed or felt, which helps in using the device without looking all the time at the screen, which enables the eyes-free-operation of the device for most time settings, so that they can be made with a single hand; with the thumb of the hand which holds the device.

### BACKGROUND

1. Field

The aspects of the disclosed embodiments generally relate to communication devices and personal digital assistant (PDA) style devices, and in particular to a timed mode setting in a mobile device.

2. Brief Description of Related Developments

The typical mobile device, such as for example a mobile communication device, will have one or more operating modes or profiles. These can include for example, normal, silent, meeting, outdoor, pager and offline. The settings of mobile devices are typically grouped in these modes or profiles, where each different mode generally provides a number of different settings for the input and output functions and alerts of the device. Some of these settings can include, for example, a ringing tone, ringing type, ringing volume, message alert tone, email alert tone, vibrating alert, keypad tones, warning tones, alarm tones of appointments in a clock and/or calendar application, haptic feedback of the input interface, and other functions and alerts. Each of the different modes or states is generally customizable by the user.

Depending on the particular situation or environment, the user may wish to activate or deactivate one or more of the functions or operations of the device. For everyday situations the “normal” mode or profile might be selected, which can provide typical alerts and ring tones. When the user is in large or noisy environments, the “outdoor” setting may be selected, which can be configured either by the user or by default to provide enhanced or more intense (louder, for example) alerts. However, there are situations when the user may not wish to have audible or otherwise normal alerts. For example, when the user is in a meeting or a quiet environment, minimal interruption may be desired. In this case, the “meeting” profile might be selected, where, if so customized, only non-audio alerts are provided. Alternatively, the “silent” mode can be selected, where typically the ringing, keypad and alert tones are all disabled or inhibited. It can also be practical to utilize timed profiles, such as a “Timed Silent” or “Timed Meeting” profile, which sets a time period during which the device will use the Silent or Meeting profile, respectively. Alternatively, the Timed Silent or Timed Meeting mode may only set an expiration moment for the timed profile, which generally starts from the moment when the expiration moment was set, and continues to the expiration moment when the device is automatically reverted back to the previously used profile, or starts using another profile.

However, activating any one of the modes of the device, as well as adjusting or customizing the various settings, usually involves a number of steps and settings. For example, on a typical mobile communication device, to engage the mode setting state, the user must scroll to and/or select the menu option that corresponds to the mode setting state. Once in the mode setting state, a desired or particular mode must be scrolled to in a menu and activated. If any one of the settings, such as the expiration moment of the timed silent profile, is desired to be adjusted, it is necessary to navigate to the particular setting, and then adjust the setting values.

Thus, although it is relatively easy to use the mode and time setting features of mobile communication devices, the setting adjustment process generally requires several menu selections and key presses. As another example, the setting of an expiration moment for a “Timed Silent” mode can be done with a numeric keypad by entering the 2-4 digits of the new expiration moment, and pressing several buttons to open the time setting screen. These operations typically require the user to be looking at the device and require two-handed operation. In mobile phones that use for example the “S60™ 5^{th} edition” user interface of Nokia™, to set an expiration moment for a timed mode or profile, the buttons or keys (which can include menu setting selections) must be pressed or activated anywhere between 12-19 times. In some situations, adjusting these settings can take more time than the user has available, or can be overly distracting. For example, a situation may arise where the user wants to immediately silence the device and activate the Silent profile, or activate a Timed Silent profile for a certain time period. It would be advantageous to make these types of adjustments easily with a minimal amount of attention and interaction. It would also be advantageous to be able to make these types of adjustments with a single hand and without the need to put “eyes on” the device to a great extent (for “eyes-free” operation, for example).

Accordingly, it would be desirable to address at least some of the problems identified above.

### SUMMARY

In one aspect a method includes using a device to detect a signal corresponding to a sliding input on a touch sensitive area of the device, the sliding input being for a time setting adjustment. A time unit corresponding to a start point of the sliding input is determined, and if the signal indicates that the sliding input is substantially in a first direction, a time setting of the corresponding time unit is increased by a pre-defined increment, and if the signal indicates that the sliding input is substantially in a second direction, the time setting of the corresponding time unit is decreased by a pre-defined increment. Feedback signals are provided at regular intervals of length, along or corresponding to the route of the sliding movement. Those feedback signals can be sensed or felt, which helps in using the device without looking at the screen. This enables the eyes-free-operation of the device for most time settings, so that they can be made with a single hand, for example with the thumb of the hand which holds the device.

In another aspect, an apparatus includes at least one processor and at least one memory including computer program code, the at least one memory and the computer program code configured to, with the at least one processor, cause the apparatus at least to perform: detecting a signal corresponding to a sliding input on a touch sensitive area of a device, the sliding input being for a time setting adjustment; determining a time unit corresponding to a start point of the sliding input; and if the signal indicates that the sliding input is substantially in a first direction, increasing a time setting of the corresponding time unit by a pre-defined increment; and if the signal indicates that the sliding input is substantially in a second direction, decreasing the time setting of the corresponding time unit by a pre-defined increment.

In a further aspect, a computer program product includes a computer-readable medium bearing computer code embodied therein for use with a computer, the computer program code having code for detecting a signal corresponding to a sliding input on a touch sensitive area of a device, the sliding input being for a time setting adjustment; code for determining a time unit corresponding to a start point of the sliding input; and if the signal indicates that the sliding input is substantially in a first direction, code for increasing a time setting of the corresponding time unit by a pre-defined increment; and if the signal indicates that the sliding input is substantially in a second direction, code for decreasing the time setting of the corresponding time unit by a pre-defined increment.

### BRIEF DESCRIPTION OF THE DRAWINGS

The foregoing aspects and other features of the embodiments are explained in the following description, taken in connection with the accompanying drawings, wherein:

FIG. 1 is a block diagram of an exemplary device incorporating aspects of the disclosed embodiments;

FIGS. 2A-2F illustrate aspects of the disclosed embodiments;

FIGS. 3A-3F illustrate aspects of features of the disclosed embodiments;

FIGS. 4A and 4B are illustrations of exemplary devices that can be used to practise aspects of the disclosed embodiments;

FIG. 5 illustrates a block diagram of an exemplary system incorporating features that may be used to practise aspects of the disclosed embodiments; and

FIG. 6 is a block diagram illustrating the general architecture of an exemplary system in which the devices of FIGS. 4A and 4B may be used.

### DETAILED DESCRIPTION OF THE EMBODIMENTS

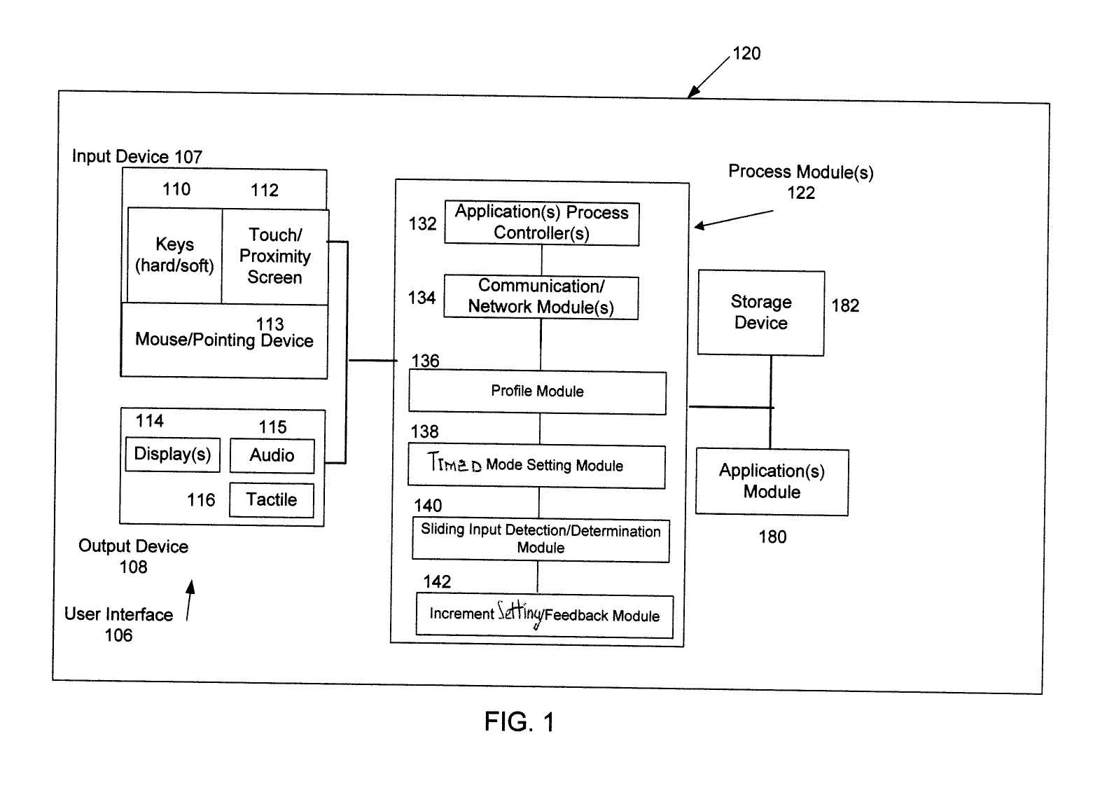

FIG. 1 illustrates one embodiment of a device 120 with which aspects of the disclosed embodiments can be applied. Although the disclosed embodiments will be described with reference to the embodiments shown in the drawings and described below, it should be understood that these could be embodied in many alternate forms. In addition, any suitable size, shape or type of elements or materials could be used.

The aspects of the disclosed embodiments are generally directed to allowing for adjusting and/or setting the expiration moment in a timed mode or profile with a few simple sliding movements or gestures on a touch sensitive area of a device 120. What is generally described herein as the “setting of a timed mode”, or the “setting of the Timed Silent profile” is applicable to any setting or adjustment of time or date in an application, such as for example, a clock or calendar application of the device 120. The term “expiration time” as used herein generally applies to the length of any time period that is adjusted, and the term “expiration moment” is generally applicable to the moment at the end of any time period, the length of which is adjusted.

Although the aspects of the disclosed embodiments will be described herein with reference to a “Silent” or “Timed Silent” mode or profile, in alternate embodiments the profile can be any suitable timed profile or state of the device 120 that requires a time setting or adjustment to be made.

In one embodiment, the sliding gesture can be in the form of a substantially straight or slightly curved line. In general a sliding input or gesture can include any movement of an object on or along a touch screen or touch-sensitive input portion of a device. It is an advantage of the aspects of the disclosed embodiments to allow for a gesture that matches the natural movement of the user's fingers, such as the thumb for example, particularly when the operations are being carried out in a one-handed manner, for example when the device is held either in the left or right hand. The aspects of the disclosed embodiments generally allow the gestures to be applied using the same hand that is holding the device, leaving the other hand free for other tasks. The gestures can be applied to the device in a touch sensitive area, such as a slidepad, or the touch-sensitive surface of the display panel, for example. In some examples, expiration times of virtually any duration, or any setting of time or date, can be set very easily, and without the need to have to be viewing the device, or the touch sensitive area to which the gesture is being applied, during the operation of the device 120.

FIG. 1 illustrates one embodiment of an exemplary device or apparatus 120 that can be used to practise aspects of the disclosed embodiments. The device 100 of FIG. 1, which in one embodiment is a communication device, generally includes a user interface 106, process module(s) 122, application module(s) 180, and storage device(s) 182. In alternate embodiments, the device 120 can include other suitable systems, devices and components that provide for time settings and adjustments, in for example, a timed profile setting adjustment state, or any time or date setting in a device using one-handed gestures. The components described herein are merely exemplary and are not intended to encompass all components that can be included in, or used in conjunction with the device 120. The components described with respect to the device 120 will also include one or more processors or computer program products to execute the processes, methods, sequences, algorithms and instructions described herein. Although the aspects of the disclosed embodiments will be generally described with respect to a mobile communication device, the aspects of the disclosed embodiments are not so limited, and in alternate embodiments the device 120 comprises any suitable device such as a personal digital assistant (PDA) device, e-book reader, or a personal computer, for example. The user interface 106 of the device 120 generally includes input device(s) 107 and output device(s) 108. The input device(s) 107 are generally configured to allow for the input of data, instructions, information gestures and commands to the device 120. The input device 107 can include one or a combination of devices such as, for example, but not limited to, keys or keypad 110, touch sensitive area 112 or proximity screen and a mouse or pointing device 113. In one embodiment, the keypad 110 can be a soft key or other such adaptive or dynamic device of a touch screen 112. The input device 107 can also be configured to receive input commands remotely or from another device that is not local to the device 120. The input device 107 can also include camera devices (not shown) or other such image capturing system(s).

The output device(s) 108 is generally configured to allow information and data to be presented to the user and can include one or more devices such as, for example, a display 114, audio device 115 and/or tactile output device 116. In one embodiment, the output device 106 can also be configured to transmit information to another device, which can be remote from the device 120. While the input device 107 and output device 108 are shown as separate devices, in one embodiment, the input device 107 and output device 108 can comprise a single device or component, such as for example a touch screen device, and be part of and form, the user interface 106. For example, in one embodiment where the user interface 106 includes a touch screen device, the touch sensitive screen or area 112 can also provide and display information, such as keypad or keypad elements and/or character outputs and/or graphic outputs in the touch sensitive area of the display 114. While certain devices are shown in FIG. 1, the scope of the disclosed embodiments is not limited by any one or more of these devices, and alternate embodiments can include or exclude one or more devices shown.

The process module 122 is generally configured to execute the processes and methods of the aspects of the disclosed embodiments. As described herein, the process module 122 is generally configured to detect a user input during a timed mode setting adjustment state, determine whether the input corresponds to a time setting input profile and set a time period or expiration moment for the profile, or to any time or date setting input, accordingly.

In one embodiment, the process module 122 includes a Profile Module 136, a Timed Mode Setting Module 138, a Sliding Input Detection/Determination Module 140 and an Increment Setting/Feedback Module 142. The Profile Module 136 generally controls the various profiles that are available in the device 120. The Timed Mode Setting Module 138 is generally configured to control the feature settings for the timed profile, including the setting or adjustment of the expiration moment for the timed profile. The Sliding Input Detection/Determination module 140 is generally configured to detect sliding input gestures, determine if the gestures correspond to command inputs for the timed profile, and provide setting and adjustment instructions to the Timed Mode Setting Module 138. The Increment Setting/Feedback module 142 is generally configured to provide sensory feedback to the user related to the adjustment of the expiration moment setting, particularly for “eyes-free” operation. In alternate embodiments, the process module 122 can include any suitable function or application modules that provide for detecting a sliding gesture on a touch sensitive area of a device 120 and interpret the gesture as a time setting command for adjusting an expiration moment of a timed profile in the device 120, or the time and date setting of other applications, which can also be controlled by the Sliding Input Detection/Determination module 140.

Although the present application is generally described with respect to adjusting time settings, in alternate embodiments, the aspects of the disclosed embodiments can be used to provide adjustments to any suitable application or device. For example, with similar single-handed gestures, using the natural movements of the thumb of the hand that holds the device, other adjustments can be provided, such as adjusting the number of an audio track of a multimedia item that is played with the multimedia application of the device, and non-numeric variables that use several pre-defined levels, such as the audio volume of various alert and alarm signals, as well as the volume of the voice that is reproduced by the earpiece or loudspeaker of the device.

The application process controller 132 shown in FIG. 1 is generally configured to interface with the application module 180 and execute application processes with respect to the other modules of the device 120. In one embodiment the application module 180 is configured to interface with applications that are stored either locally to or remote from the device 120. The application module 180 can include any one of a variety of applications that may be installed, configured or accessed by the device 120, such as for example, office and business applications, calendar and clock applications, media player applications, multimedia applications, web browsers, global positioning applications, navigation and position systems, and map applications. The application module 180 can also include a voice recognition system that includes a text-to-speech module that allows the user to receive and input voice commands, prompts and instructions, through a suitable audio input device. In alternate embodiments, the application module 180 can include any suitable application that can be used by or utilized in the processes described herein.

The communication module 134 shown in FIG. 1 is generally configured to allow the device 120 to receive and send communications and data including for example, telephone calls, text messages, location and position data, navigation information, chat messages, multimedia messages, video email, and the data of synchronized calendar and clock applications. The communications module 134 is also configured to receive information, data and communications from other devices and systems or networks, such as for example, the Internet. In one embodiment, the communications module 134 is configured to interface with, and establish communications connections with other services and applications using the Internet.

The aspects of the disclosed embodiments utilize signals corresponding to the sliding inputs or gestures that are configured to be detected by the Sliding Input Module 140 to adjust time settings, such as mode-expiration settings (particularly for the expiration of a timed mode). Typically, in this mode, the user uses the current time as the baseline or activation time of the timed mode. In other time settings, the noon (12 o'clock) is typically used as the baseline for the starting time of the meeting or event in a calendar application and the starting time is used as the baseline for its end time. The user may then wish to set a time at which the timed mode will expire, after which the device 120 will return to the Normal mode, to a previous mode or to another profile. The moment at which the device 120 activates another mode after an expiration of a timed mode is generally referred to herein as the “expiration moment.” The sliding input or gesture described herein is used to adjust certain lengths of time, or a moment of time (in days, hours, minutes, and seconds, for example). Typical applications for the adjusted time are the expiration moment of a timed profile or mode (which controls various control signals; visual, aural or tactile), or appointments or events in the calendar application of the device, or alarm times of the clock or calendar application of the device. In certain examples and figures described herein the time adjustments are made with respect to the expiration moment of a timed profile, which at its expiration moment automatically turns to another profile.

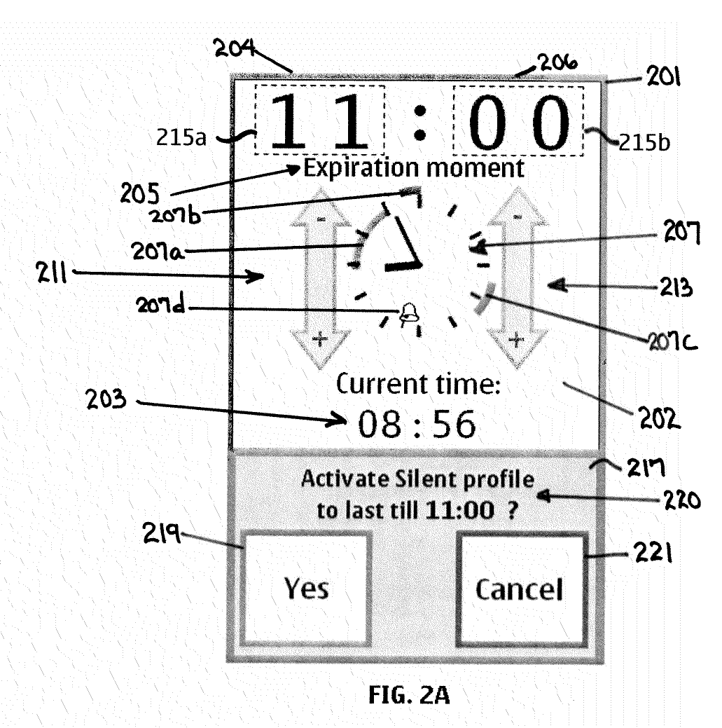

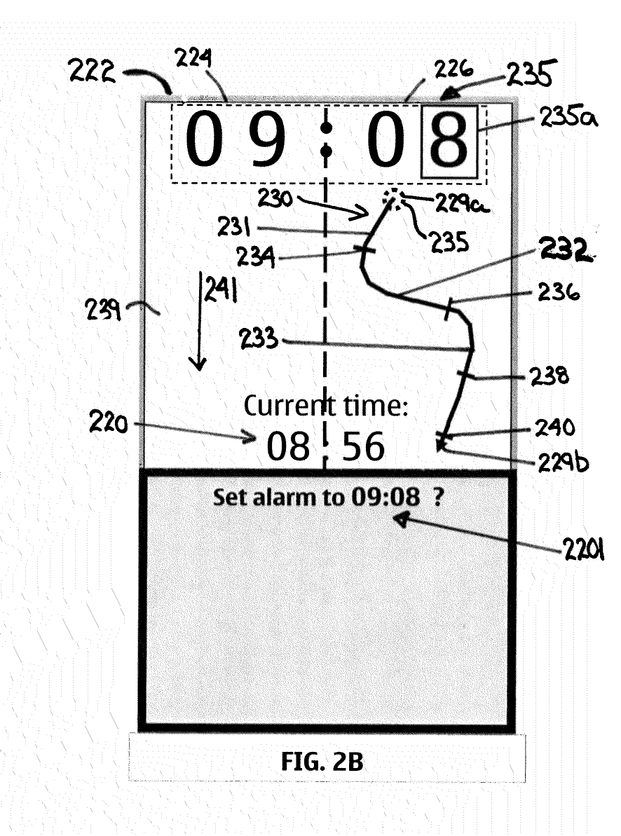

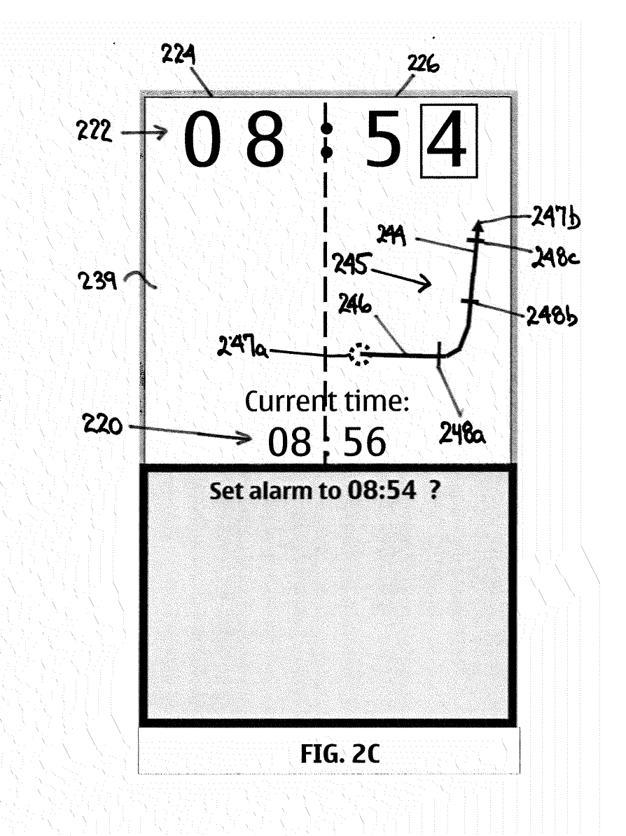

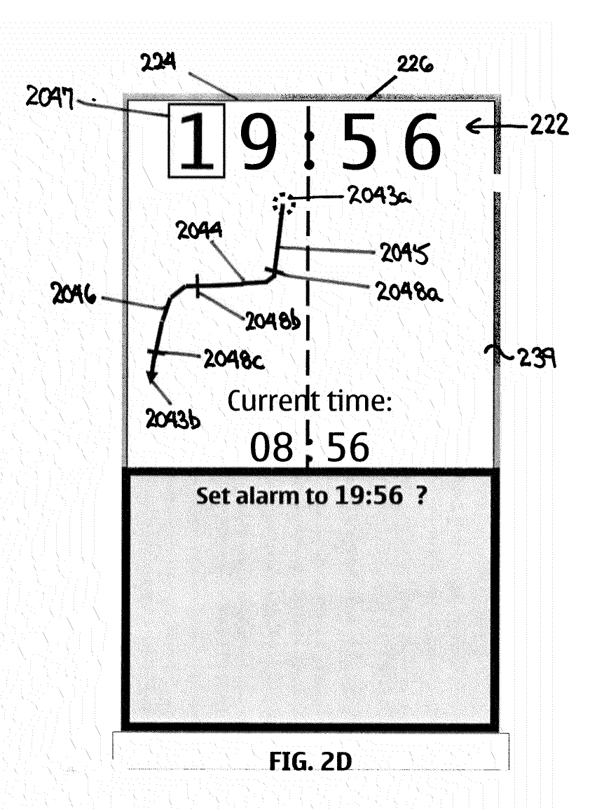

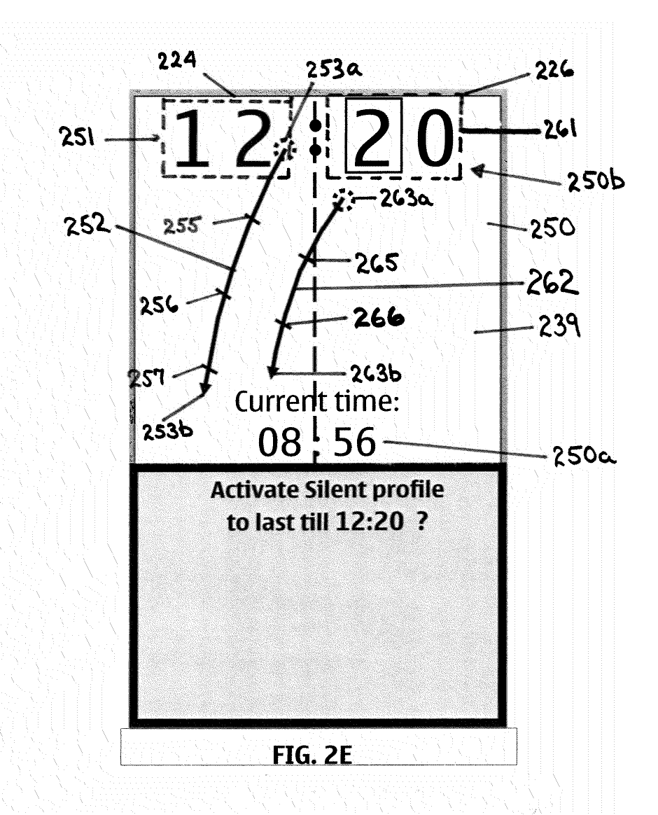

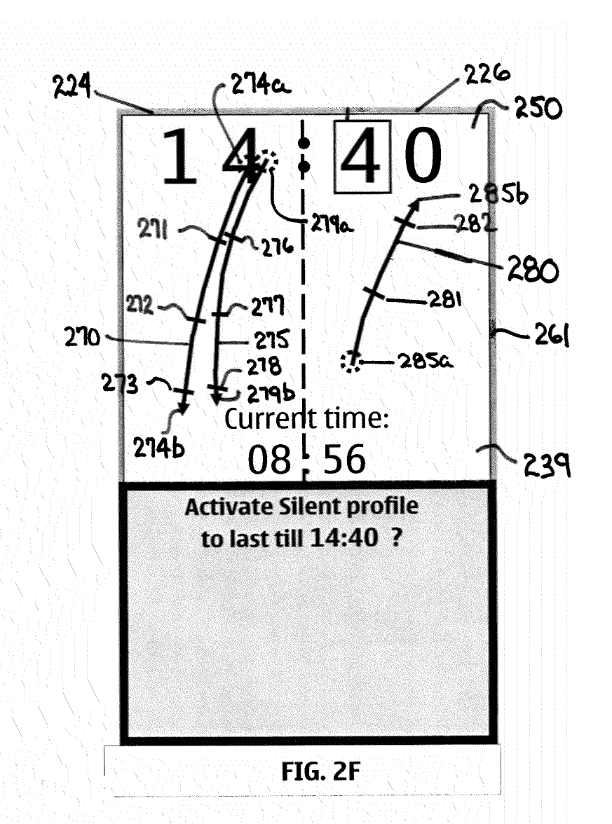

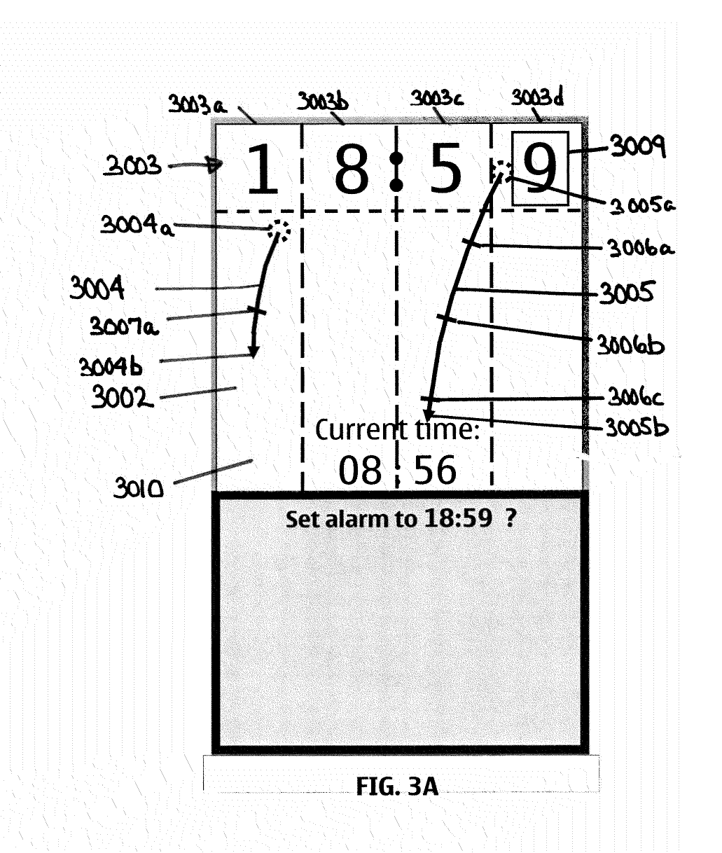

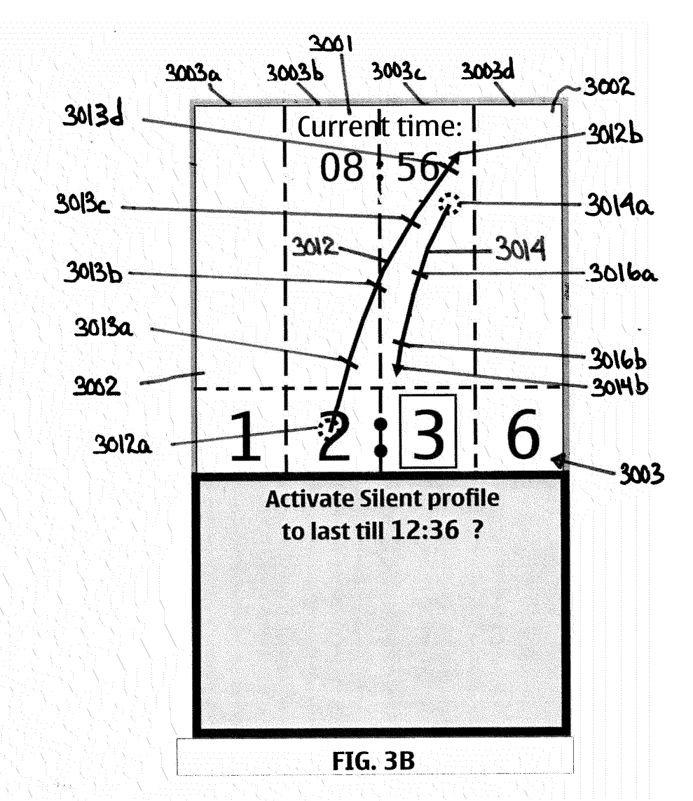

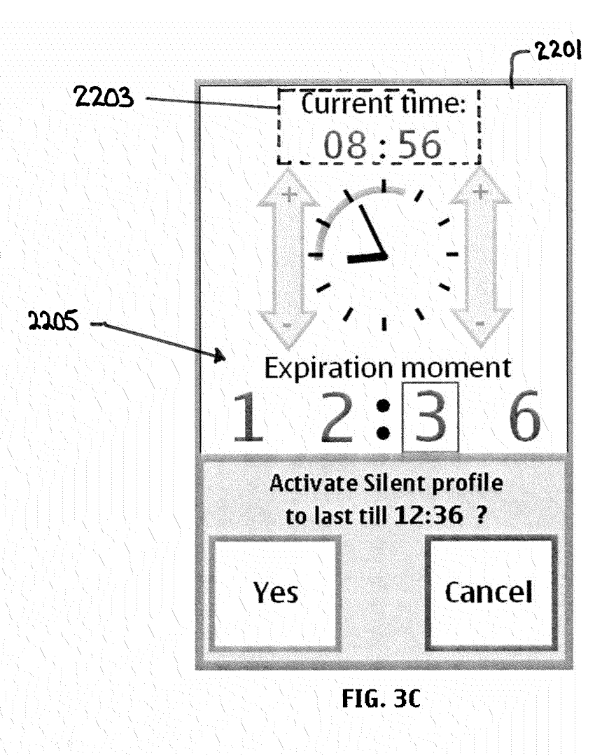

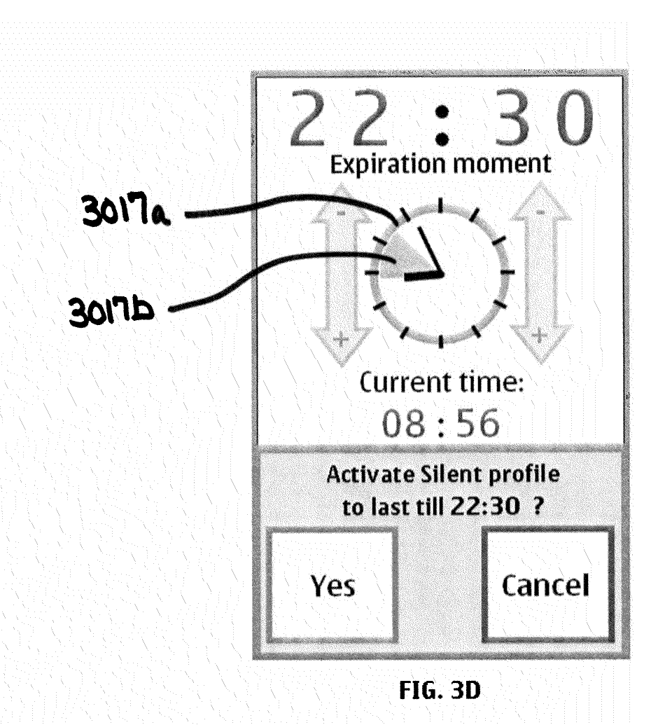

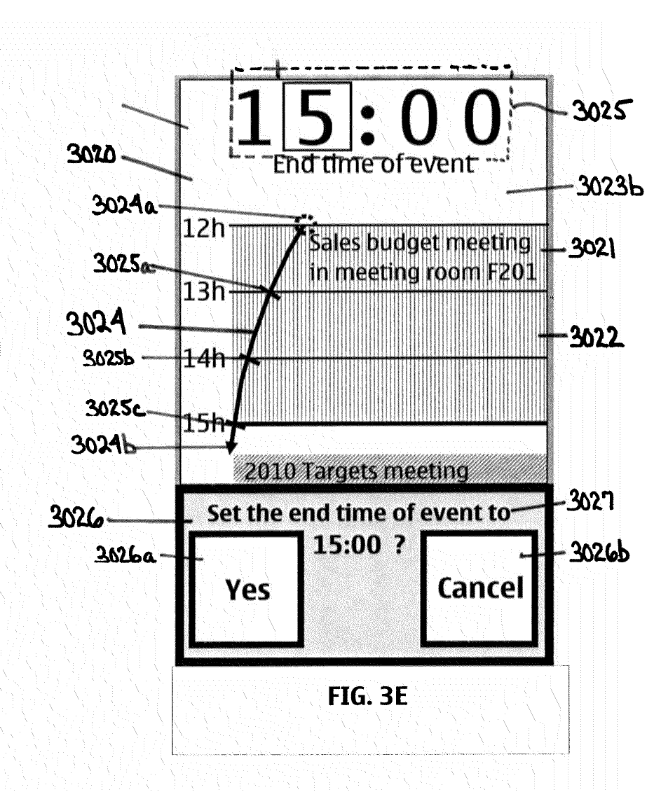

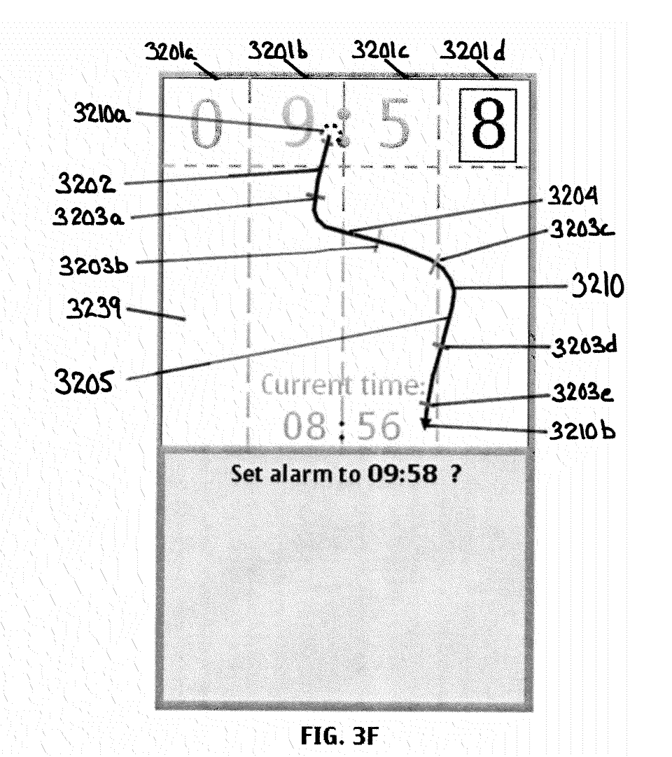

In one embodiment, referring to FIG. 2A, a time setting screen 201 for an exemplary Timed Silent profile is illustrated. The time setting screen 201 generally allows the user to adjust or set the expiration moment for the timed profile represented by the screen 201. As shown in FIG. 2A, the time setting screen 201 includes an area or field 203 for displaying the current time, and an area or field 205 for displaying the resulting expiration moment. In the embodiment shown in FIG. 2A, the field 205 includes an hours' section 215a and a minutes section 215b. The dotted lines for sections 215a and 215b shown in FIG. 2A are for illustration purposes only. The relative positions, locations and configurations of areas 203 and 205 of the time setting screen 201 are merely exemplary, and not intended to limit the scope of the present application. In one embodiment, (analog or other suitable) time indicating screen 207, which in this example is 12-hour analog clock, can also be used or included as part of the screen 201. In one embodiment, the highlighted arch 207a along the circle of the 12-hour analog clock 207 can display or indicate the set time when the device 120 is in the timed mode. Also other appointments or events can be displayed as arches, such as 207b and 207c in FIG. 2A, in analog clock 207. This provides a visualization of the set time in a pictorial, quick-to-see way, and helps in determining, how the set time (of the Timed Silent profile, for example) relates to other appointments or events that have been saved to the calendar application of the device 120, and to the current time. In one embodiment, reminders and alarms 207d of clock and calendar applications can be displayed in the clock 207. In one embodiment, the arch 207a of the set timed profile can be displayed in a different color than the arches which represent the times of the appointments or events which have been set with the calendar application of the device. If the length of the timed mode, appointment or event exceeds 12 hours, the next hours (up to the length of another 12 hours' period) can be displayed as a segment in the center of the analog clock. In FIG. 3D, the outer segment (the full circle) 3017a indicates the first 12 hours (from 08:56 till 20:56 o'clock), and the inner segment 3017b indicates the remaining part (from 20:56 till 22:30 o'clock) of the timed profile.

In one embodiment, the time setting screen 201 is a touch sensitive area of the device 120. The touch sensitive area can be a touch sensitive display or a slide input area, for example, and will generally be referred to herein as the “slidepad area” 202. In one embodiment, by providing a sliding movement or gesture in the left-hand half 204 of the slidepad area 202 (on, near or below the two hours' digits 215a), the user can adjust the expiration moment 205 in hours' increments, which changes the hours' digits 215a. A sliding movement or gesture in the right-hand half 206 of the slidepad area 202 (on, near or below the two minutes' digits 215b), will adjust the expiration moment 205 in minutes' increments.

In one embodiment, a sliding movement of a pre-defined length will adjust the time by one unit of increment. For example, a unit of increment for the two hours' digits 215a can be one hour, while the unit of increment for the two minutes' digits 215b can be 10 minutes. In alternate embodiments, any suitable value can be used for the unit of increment and the units of increment could be configurable by the user in some embodiments. The length of movement of the gesture to advance the respective digits 215a, 215b by one unit of increment can be any suitable predefined length. In one embodiment, a sliding movement of 8 millimeters can be used to advance the respective digits 215a or 215b by one increment. Although the distance between increment points is generally described herein as being along the route of the gesture, in alternate embodiments, the distance between increment points can be measured in any suitable manner. In one embodiment, the distance between increment points can be the shortest distance between the increment points. For example, the criterion of distance can be applied as measured along a straight line between two subsequent increment points. These increment distances can also be applied to the distance between a starting point of a gesture and its first increment point.

In this example, if the sliding movement is 40 millimeters, then the adjusted time will change by five units of the time increment. In the following examples, the increment value or unit is 1 hour on the hours' half 204 of the slidepad area 202, and 10 minutes on the minutes' half 206 of the slidepad area 202. In alternate embodiments, the increment unit can be any suitable distance, other than including 8 millimeters.

In one embodiment, the sliding movement needed to adjust the hour and minute digits 215a, 215b is substantially an “up and down” or “vertical” movement in the slidepad area 202. As used herein, the terms “horizontal” and vertical” will generally correspond to the directions of the X and Y axes of a display screen. As shown in the example of FIG. 2A, the hours of the desired expiration moment are adjusted with a sliding touch movement in the left-hand half 204 of the slidepad 202 (on or around area 211), and the minutes of the desired expiration moment are adjusted with a sliding touch movement in the right-hand half 206 of the slidepad 202 (on or around area 213). The two-way arrows in areas 211 and 213 shown in FIG. 2A merely illustrate the sliding and directional orientations. As shown in FIG. 2A, a sliding DOWN movement can be used to increase the expiration moment setting, while a sliding UP movement can be used to decrease the expiration moment setting. In alternate embodiments, any suitable sliding direction can be used to increase or decrease the expiration moment setting. Thus, when the thumb is used as the sliding motion input device, the user can manipulate the device 120 and provide the required sliding input with one hand.

Generally, a simple sliding movement of a certain length in either the up or down direction will cause a corresponding change of the hours' or minutes' pair of digits (215a or 215b, respectively). The sliding movement can be of any suitable length and speed. In one embodiment, the sliding movements are regarded as “normal” if the speed of sliding does not exceed a certain limit (40 millimeters per second, for example). The speed of the sliding movement can also be used to step the increment changes at different rates. For example, in one embodiment, each adjustment area on or around 211, 213 can be configured so that a “quick” sliding motion will be interpreted as an instruction to change respective digit portion 215a, 215b by a pre-defined amount that is greater than the “normal” unit of increment. This effect allows the user to quickly adjust the time, rather than gradually stepping through a high number of the increments. Thus, instead of using the “normal” increment, a “quick” slide can result in a digit change that is a multiple of the standard increment. For example, if the standard length of sliding is 8 millimeters for an increment change of one hour in the left-hand half 204 of the slidepad area 202 and an increment change of 10 minutes on the right-hand half 206 of the slidepad area 202, a “quick” slide of more than 8 mm, but less than 16 mm, at a speed that exceeds the upper limit of the “normal” rate of slide, can result in a change of three hours in the left-hand half 204 of the slidepad area 202, and 30 minutes in the right-hand half 206 of the slidepad area 202. In alternate embodiments, the change can be any suitable or pre-defined “quick” increment change. A sliding movement will be interpreted or regarded as “quick” if the speed of sliding exceeds a certain limit (40 millimeters per second, for example). In alternate embodiments, any suitable slide length and speed can be used for a quick increment change.

In one embodiment, the change from the predefined “normal increment” to a “multiplied increment” can be done by touching and holding the finger or a pointing instrument at the starting point of the sliding movement for longer time than a certain limit (such as 1 second). The sliding movement is then continued for a desired length, without raising the finger or stylus until the sliding movement has been completed. For example, if the required length of the sliding movement is 8 millimeters for the “normal increment” of one hour, and its “multiplied increment” of the same length of 8 millimeters has been defined to be three hours on the left-hand half 204, and 30 minutes on the right-hand half 206, the time adjustment can be increased with three hours by touching and holding anywhere on the hours' half 204 of the slidepad area 202 (but not too near its bottom) for a pre-determined time period, such as more than one second, and then, without raising the finger or stylus, sliding the finger or stylus downwards for more than 8 millimeters but less than 16 millimeters, after which the finger or stylus can be raised. Similarly, the time adjustment can be increased with 30 minutes with a similar “hold and slide downwards” gesture, which must be longer than 8 millimeters but shorter than 16 millimeters—the only difference being that the starting point of the gesture must be on the minutes' half 206 of the slidepad area 202. The time periods mentioned herein are merely exemplary, and in alternate embodiments, any suitable time periods can be used.

During the sliding gesture, in one embodiment, the user can also be provided with sensory feedback with each increment change. For example, haptic feedback signals (“kickbacks”) or audio tones (“ticks”) can be provided at each time increment point during the sliding gesture. In alternate embodiments, any suitable sensory feedback can be provided. Thus, if the user wishes to set the timed profile to be active for a four-hour period from the current time, and the time setting increment is one hour, a sliding gesture of a length that traverses four increments is required. For example, if a normal-speed sliding movement of 8 millimeters is required per each increment of one hour, for the four-hour adjustment, a sliding movement of equal to or more than 32 but less than 40 millimeters (with normal speed) is needed. In this embodiment, four feedback signals will be given, one at each 8 millimeters' interval or increment. Each feedback signal can include one or more of an audible indication, such as a beep or click (a “tick”), a visual indication in the form of a change in lighting on the display, or a haptic (tactile “kickback”) indication, such as a short vibration of the device or its display panel. The foregoing is merely illustrative of the types of feedback that can be provided and is not intended to encompass all possible options and combinations thereof. For example, different kinds of feedback can be given for different settings. One type of feedback signal can be provided for the setting of hours (and also minutes) with normal speed of sliding, while another type of feedback signal can be provided for the setting of hours (and minutes) with the “multiplied increment” sliding. In one embodiment, when making gestures with the “multiplied increments” input style, a feedback signal can be given when the finger or stylus has been held on the starting point for the predefined minimum time (of 1 second, for example), to indicate that the sliding movement can be started.

The increment feedback of the disclosed embodiments provides an advantage in that the user does not have to look at the display to know or perceive the increment adjustment that is being made. The user is able to sense or feel each increment change and the total change in the time, as a function of the number of feedback signals sensed or felt. Different feedback signals can be provided for different increment settings.

When setting the expiration moment of the timed profile, an accuracy of one minute is not usually needed. In these embodiments, any suitable accuracy increment can be used, such as an increment of 5, 10 or 15 minutes. In alternate embodiments, any suitable increment can be used for the hour and minute adjustments.

In one embodiment, referring to FIG. 2A, before accepting a time adjustment as the expiration moment to be set, the user can be provided with a prompt 220 to accept the adjustment as the new expiration moment. For example, as shown in FIG. 2A, a selection window 217 is provided with options to select 219 or reject 221 the time adjustment or expiration moment setting shown in field 205 of the time setting window 201.

In one embodiment, the user is not presented with a visual cue for accepting a time adjustment as the new expiration moment setting. Rather, an elapsed time from a gesture input can be interpreted as an acceptance of the time adjustment for the new expiration moment. For example, referring to FIG. 2F, multiple gestures 270, 275 and 280 are shown as the inputs for adjusting the expiration moment. The measure of whether to accept a gesture as a final gesture prior to setting the expiration moment can be the expiration of a pre-defined time interval from the last gesture or movement. Once a gesture input is detected, the time adjustment will be accepted as the new expiration moment. For example, referring to FIG. 2F, a start point 274a and an end point 274b of gesture 270 is detected. In one embodiment, the endpoint 274b can be detected by a lack of contact with the touch sensitive area 250. In alternate embodiments, any suitable method of detecting an end of a gesture can be utilized, such as for example a lack of movement at any point after the start point 274a, or after one of the increments 271, 272 or 273. If after passing an increment point (271, 272 or 273) another gesture is not detected within a pre-defined time interval (three seconds, for example), the time adjustment of an ended gesture will be accepted as the new expiration moment. However, if another gesture, such as gesture 275, is detected prior to the expiration of the pre-defined time interval, the time adjustment will continue.

On top of the screen, in field 222 in FIG. 2B, is displayed the “initial time”, which for the setting of timed profiles is the current time (from which the timed mode is started), or a predefined time (noon or 12:00 o'clock, for example) in clock and calendar applications. When a time-setting gesture has been completed, field 222 changes to the adjusted expiration moment or alarm time. In one embodiment, when making a time adjustment, the total sum of the time-adjusting operations is added to the “initial time”. For example, in FIG. 2B, the total effect of the sliding gesture 233 is +12 minutes, which, when added to the initial time, which before making the gestures is the same as the current time 08:56, results in an expiration moment of 09:08, which is presented in field 222. In one embodiment, the displayed time in field 222 can change at every increment point reached or passed by the time-setting gesture. In the examples of all the drawings 2B . . . 3C, this time-setting method of “coupled hours and minutes” is applied.

In another embodiment, the adjustments to each of the hours' digits 215a in FIG. 2A and the minutes' digits 215b in FIG. 2A do not affect each other. In this embodiment, if a gesture is started in the minutes' half of the slidepad area, and has the length of two increments, each of 10 minutes, the initial minutes' digits of :56 will change to :16, and the initial time of 08:56 will change to 08:16. This time-setting method of “independent hours' and minutes' digits”, although not used in the examples of FIGS. 2A . . . 3C, may be useful for the setting of fixed dates or times, the setting of a certain day in a calendar application, or for the setting of a reminding alarm in a clock and calendar application.

In the field 222 of the adjusted time in FIG. 2B the digit 235 is highlighted, which corresponds to the active increment value of the time setting (during the sliding movement) and to the latest used increment value after making the gesture. In FIGS. 2B . . . 3C the adjusted time shown is the adjusted time at the end of making all the illustrated time-setting gestures. In those figures, the digit which corresponds to the increment unit that was used by the last sliding movement is highlighted. In FIG. 2B the highlighting is indicated by the rectangle 235a.

The aspects of the disclosed embodiments can utilize different types of gestures to adjust the expiration moment settings. The start point of the sliding gesture is used to determine which time unit of the expiration moment is to be adjusted. In one embodiment, referring to FIG. 2B, a curved gesture which is started on the right-hand half 226 of the slidepad 239, can be used to adjust both the time setting and to change between the two increment values that are available in the minutes' adjustment area (between 10 minutes and 1 minute, for example). As shown in FIG. 2B, curved gesture 230 begins at start point 229a and moves in a substantially downward direction as represented by the arrow 241, toward the end point 229b. Gesture 230 includes substantially vertical portions 231, 233, and a substantially horizontal portion 232.

In this example, the orientation of the slide portion 232 is generally horizontal. Although the aspects of the disclosed embodiments are generally described with respect to vertical and horizontal movements, the sliding gesture need not be exactly vertical or horizontal in relation to the screen edges. Wide tolerances can be allowed in the direction of the sliding movement, wherein the gestures can be curved, such as when matching the natural movement of the thumb of a hand holding the device. In one embodiment, horizontal sliding gestures can have a deviation of ±30 degrees relative to the corresponding horizontal screen edge, while vertical sliding gestures can have deviations of ±45 degrees relative to the corresponding vertical screen edge.

In one embodiment, the substantially horizontal portion 232 during the gesture 230 is interpreted by the module 142 as an increment value adjustment. In this example, the change between the predefined increments is not made until the substantially horizontal sliding movement has reached a predefined length, which is typically the same length that is needed for the incremental feedback of the substantially vertical portions of the time-setting gestures. For example, a horizontal movement 232 from left to right, that has a length of at least 8 millimeters will be long enough to change the increment (from the predefined 10 minutes to the pre-defined 1 minute, for example).

In one embodiment, the horizontal sliding movement 232 shown in FIG. 2B can also be accompanied by a sensory feedback that allows the user to confirm that the movement of the horizontal portion is long enough for the changing of the increment value, without having to view the display, which enables eyes-free operation. In one embodiment, visual cues are not provided and points (“markers”) that the sliding movement must pass in order to produce an increment, shown in the drawings, do not replicate on the display. The function of the sensory feedback can be similar to the feedback described above with respect to the time setting and the types of sensory feedback used can be different for each increment. In the example of FIG. 2B, there is an increment change of 10 minutes at point 234, a change in the increment value from 10 to 1 minute at point 236, and a change in the increment of 1 minute at 238 and 240. In order to readily perceive and distinguish between the different increments and the changes of increment value, sensory feedback is provided in conjunction with each point.

In the example shown in FIG. 2B, the gesture 230 is started in the minutes' portion 226, (on the right-hand half of the touch sensitive slidepad 239). The initial increment value in this example is the predefined ten minutes, meaning that a sliding movement which has the length of at least one increment unit will change the time by ten minutes. In FIG. 2B, the first vertical portion 231 of the gesture 230 adds one increment unit to the time because it reaches the point 234, which along the sliding route is at 8 millimeters' distance from the starting point 229a. The substantially horizontal slide portion 232 to the right changes the increment adjustment value from ten minutes to one minute, because the horizontal slide portion 232 is long enough to reach the point 236. In one embodiment, feedback signals are provided as the movement reaches each of the points 234 and 236. The feedback signals can be the same or different, in order to differentiate the different adjustments of increments and time. The point 236 is at one increment, or 8 millimeters' distance, from the start of the substantially horizontal portion 232 of the sliding movement 230. After the horizontal slide portion 232, the next vertical slide portion 233 reflects an additional increase of two minutes to the time setting adjustment, when points 238 and 240 have been passed. In one embodiment, this adjustment can be sensed or felt, because after the feedback signal of the changed (1 minute's) increment is given, feedback signals are given at points 238 and 240. The curved gesture 230 of FIG. 2B provides the total addition of 12 minutes (12=10+2) to the time setting.

In the example of FIG. 2B, the gesture 230 is made to set an alarm. In this embodiment, the confirmation message 2201 asks for confirmation of the alarm setting. As shown in field 222 on top of FIG. 2B, the alarm time is now set to 09:08.

Referring to FIG. 2C, another example of a gesture 245 that includes a horizontal slide portion 246 is illustrated. After the horizontal slide portion 246 in FIG. 2C, the next portion of the gesture can be in either the up or down in the vertical direction, depending on whether the user wants to decrease or increase the time of the setting. In the example shown in FIG. 2C, with the substantially horizontal slide portion 246 which reaches the point 248a, the user has adjusted the increment value from ten minute adjustment units to one minute adjustment units (a decrease in the increment value). The gesture 245 continues upward in a substantially vertical direction 244 toward end point 247b. The upward gesture reaches or passes, points 248b and 248c, which, as measured along the route of the gesture or as otherwise described herein, are at 8 and 16 millimeters' distances from the start of the substantially vertical portion 244 of the gesture 245. As previously described herein, in one embodiment, a gesture in an upward direction is used to decrease the corresponding time setting value. In the example of FIG. 2C, the gesture 245 is started in the minutes' portion 226 of the slidepad area 239. The upward movement portion 244 of gesture 245, which spans two markers 248b and 248c, decreases the time setting value by two increments, or two minutes in this example. In this way the alarm time, which is the application of this particular example, is set to 08:54.

The example of FIG. 2C illustrates a decrease of two minutes. Such a negative change cannot be applied to the expiration time of a time profile, which is counted from the current time 220, unless the user wants to set the timed profile to last 23 hours and 58 minutes. However, negative time adjustments can be added to the other time setting gestures. For example, if the user wants to set the expiration to take place after 3 hours and 50 minutes, a downward sliding movement in the vertical direction can be started in the hours' portion 224 of the slidepad area 239, and continued until four feedback signals are given, after which the finger or stylus is raised, and another time-adjusting sliding movement is started in the minutes' portion 226 of the slidepad area 239, and continued by sliding upwards until one feedback signal is given. In this way the user can adjust the expiration time to 3 hours and 50 minutes (=4 hours-10 minutes).

Referring to FIG. 2D, another example is illustrated where the change of incremental unit is made with a substantially horizontal movement which goes from right to the left, as part of gesture 2045, which begins in the hours' portion 224 of the slidepad area 239 at point 2043a and ends at point 2043b. In the example of FIG. 2D, the first one hour is added with a substantially vertical sliding movement so that it passes point 2048a. The increment default, which in this example is one hour, is changed to a pre-defined increment value of 10 hours, by making a substantially horizontal sliding movement 2044. The gesture reaches the point 2048b, which is at the distance of 8 millimeters along the route of the sliding movement (8 millimeters being the default length required to change the time increment) from the start of the substantially horizontal portion 2044 of the sliding movement or gesture 2045. By continuing the gesture 2045 with a downward movement portion 2046, which reaches the point 2048c, one increment of 10 hours is added to the alarm time. In this way a total of 11 hours is added, and the alarm time is set to 19:56, which is shown in field 222.

As soon as the increment is changed with the example gestures of FIGS. 2B, 2C and 2D, in the field of the adjusted time, field 222 in FIG. 2B and 2D, for example, the digit 2047 in FIG. 2D that corresponds to the current value of the increment unit that is being used, or has been used by the latest sliding movement, will be highlighted.

The example of FIG. 2A shows how a substantially vertical sliding movement that starts in one of each portion 204, 206 of the slidepad 202 (on or around regions 211 and 213) of the touch sensitive time setting screen 201 is used to adjust the expiration moment 205. In that example, the change in the time setting is determined by the number of the incremental points which the gesture reaches or passes. The start point of the sliding gesture is used to determine which default increment unit (that of the hours' digits 215a or that of the minutes' digits 215b) is going to be used for the setting of the expiration moment 205. One example of a time setting principle of the disclosed embodiments is illustrated in FIG. 2E. In the time setting screen 250 are illustrated some exemplary sliding movements which are made in the portions 224, 226 of the slidepad area 239. It is noted that although the screen 250 shows a dividing line in an approximate middle of the screen 250, such a line may or may not be provided. Solely for purposes of explanation, the dividing line is shown in the drawings. Moreover, although the routes of the sliding movements and their increment points are shown in the figures, this is merely for illustration purposes, and in alternate embodiments, the routes and increment points may or may not be displayed on the screen of the device.

In one embodiment, the touch sensitive expiration-moment-setting screen 250 displays the current time 250a, and the resulting expiration moment 250b. Although not shown in FIG. 2E, in one embodiment the screen 250 could also include informative graphics illustrating how the sliding gestures are to be made, similar to the indicator bars 211 and 213 shown in FIG. 2A. As shown in FIG. 2E, in one embodiment, the screen 250 includes an hours' digit portion 251 in the left-hand portion 224 of the slidepad area 239 and a minutes' digit portion 261 in the right-hand portion 226 of the slidepad area 239. In this embodiment, when a sliding gesture is detected, the start point of the sliding gesture determines whether the increment of the hours' adjust area or the increment of the minutes' adjust area will be used for the time adjustment. For example, as shown in FIG. 2E, gesture 252 has a start or origin point 253a in the hours' adjust area 224 of the slidepad area 239. Hence, gesture 252 will use the increment unit of the hours' adjust area regardless of the subsequent sliding route or the location of endpoint 253b.

The gesture 262 of FIG. 2E is interpreted as a minute adjustment input because the start point 263a of gesture 262 begins in the minutes' adjustment area 226. In this example, the endpoint 263b of gesture 262 ends in the hours' adjustment area 224. However, the gesture 262 will still be interpreted as a minute adjustment input by virtue of its start point 263a in the minute adjustment area 226.

For purposes of illustration, in the example of FIG. 2E, each increment 255, 256 and 257 of gesture 252 in the hours' adjustment area 224 corresponds to a one hour adjustment increment. Thus, according to this example, the expiration moment will be increased three hours from the current time setting of 08:56 (which is shown in field 250a) to 11:56. In this example, each time change at points 265 and 266 of gesture 262 is ten minutes, which means that the total of 20 minutes is added to the expiration moment. Thus, the expiration moment of the timed profile will be 12:16. In this example however, the expiration moment is rounded to the nearest multiple of the default incremental unit of the minutes' adjusting area, which is 10 minutes in this example. The expiration moment is therefore displayed as 12:20 in field 250b. In alternate embodiments, the expiration moment is not rounded.

Again with reference to FIG. 2E, at certain regular distances along each gesture 252, 262, the user can be provided with certain sensory feedback relative to each increment adjustment. For example, with respect to gesture 252, the sensory feedback is provided at the moment when the sliding movement of the gesture 252 passes each of the increment points 255, 256 and 257, which are active at regular distances along the route of the gesture 252. In this example, the increment points 255, 256 and 257 are separated by the default distances of 8 millimeters, along the route of the gesture 252, although in alternate embodiments, any suitable interval distance between the increment points can be used. The sensory feedback can be similar to the types of feedback previously described herein, and can include for example, visual, aural or tactile feedback, or any combination thereof.

In one embodiment, referring to FIG. 2F, before an expiration moment is accepted or set, additional sliding gestures can be provided in each portion 224, 226 of the slidepad area 239 to provide further adjustment of the expiration moment. For example, a first gesture 270 is detected having a start point 274a in the hours' adjustment area 226. The first gesture 270 has a length equivalent to three increments, where in this example, the hours increment is one hour. A second gesture 275 has a start point 279a in the hours' area 224. The second gesture 275 has a length equivalent to three increments. Both gestures 270 and 275 are in a substantially downward, vertical direction, which, in this embodiment, corresponds to an increase in the time increment. Thus, in this example, gestures 270 and 275 together produce an increase of 6 hours in the time adjustment: from 08:56 to 14:56 (in 24 hour standard).

Still referring to FIG. 2F, after gesture 275, a gesture 280 is detected with start point 285a in the minutes' area 226. Since gesture 280 starts in the minutes' area 226, which in this embodiment corresponds to the right-hand side of the slidepad area 250, the gesture 280 is interpreted to use the default increment value of the minutes' adjustment area, which in this example is 10 minutes. The gesture 280 has a length that traverses two time increment points, 281 and 282. Since the gesture 280 is substantially upwards, in a vertical direction, the gesture 280 is interpreted as a command to decrease the minute adjustment by 20 minutes. Thus, in this example, the expiration moment 14:56 (which was adjusted with the above described gestures 270 and 275) will be decreased by two time increments of 10-minutes each, or 20-minutes, resulting in the expiration time of 14:36. Due to rounding to the nearest multiple of the 10 minutes' incremental unit, the expiration moment in field 250b is shown as 14:40. In alternate embodiments, the resulting expiration moment is not rounded.

FIG. 3A illustrates an embodiment where the slidepad area 3010 is divided into functional time adjustment areas or columns. In this embodiment, column 3003a corresponds to the 10-hour digit, column 3003b to the 1-hour digit, column 3003c to the 10-minute digit, and column 3003d to the 1-minute digit. In alternate embodiments, any suitable time divisions can be used. Although the borders of each column 3003a-3003d are shown in FIG. 3A, this is for illustration purposes only, and in alternate embodiments, the borders will not be displayed, or can be displayed in any suitable fashion.

Referring again to FIG. 3A, time that is displayed in field 3003 can be adjusted with sliding movements which are made in the slidepad area 3002 and which start in the column of 3003a, 3003b, 3003c or 3003d, depending on the wanted time increment value; 10 hours, 1 hour, 10 minutes or 1 minute, respectively. The starting point of each sliding movement determines the increment value with which the time is adjusted. FIG. 3A illustrates an example of how 10 hours and 3 minutes are added. A sliding gesture 3004 is started at point 3004a in the column 3003a, which contains the 10 hours' digit (the default increment value of column 3003a is 10 hours) and slides downwards to endpoint 3004b. In this embodiment, a feedback signal is provided at the first multiple of its increment value (10 hours), shown for purposes of this example as point 3007a, which generally corresponds to a distance of 8 millimeters from the starting point 3004a of the sliding gesture 3004.

In the example of FIG. 3A, a second sliding gesture 3005 starts at point 3005a in the column 3003d of the 1-minute's digit. The gesture 3005 is in a downward direction. Feedback signals of three multiples of the increment value (the default value of which is 1 minute in the column 3003d) are detected at the distances of 8, 16 and 24 millimeters along the route of the gesture 3005 from the starting point 3005a. In this example, points 3006a, 3006b and 3006c are marked in FIG. 3A to illustrate where the finger or stylus is when the time adjustment is incremented. The result of gesture 3005 is a 3-minute increase to the adjusted time. In this example, the digit 3009 that corresponds to the latest used increment of 1 minute is highlighted.

FIG. 3B illustrates an embodiment in which the fields of the expiration moment 3003 and the current time 3001 are located in different areas, and the interpretation of the sliding directions is changed. In this example, the expiration moment time is increased by a sliding gesture that is substantially in an upwards direction, such as gesture 3012. Gesture 3012, which begins at point 3012a in the 1-hour digit's column 3003b and moves in a substantially upwards direction, increases the expiration moment time shown in field 3003 by four hours. Feedback signals are provided at each of four increments 3013a, 3013b, 3013c, and 3013d, which in this embodiment generally correspond to distances of 8, 16, 24 and 32 millimeters, respectively, from the starting point 3012a of the sliding gesture 3012. The gesture ends at point 3012b. After the gesture 3012, the expiration time of 12:56 will be displayed in the field 3003, which is in a location opposite of that is shown in FIG. 3A.

In this example of FIG. 3B, the expiration moment time shown in field 3003 is decreased by 20 minutes by starting another sliding gesture 3014 at point 3014a in the 10-minutes' digit column 3003c and moving the gesture 3014 in a substantially downwards direction to end point 3014b. Feedback signals of two increments 3016a and 3016b are given, generally corresponding to the distances of 8 and 16 millimeters from the starting point 3014a. The resulting expiration moment 12:36, (20 minutes decreased from 12:56), is displayed in the field 3003.

In the examples of FIGS. 2B, 2C, 2D, 3B, 3C and 3D, the times resulting from the respective time-adjusting gestures, are handled as exact times (with the accuracy of one minute.) Although the above embodiment is described with respect to a relatively exact adjustment of the time, in terms of minutes and hours, in alternate embodiments, the time adjustments can be more generalized. For example, in one embodiment, an accuracy of ten minutes can be considered acceptable for an expiration moment setting, especially if the expiration moment of a timed profile needs to be set in a hurry, such as in a meeting, for example. Hence, the displayed expiration moment can be rounded to the nearest multiple of 10 minutes, as shown in the examples of FIGS. 2E and 2F. In alternative embodiments, any suitable rounding can be implemented. For example, the minute settings can be rounded to the nearest multiple of 15 or 30 minutes.

FIG. 3C also illustrates an example where the relative positions of the current time and expiration moment have been changed from prior embodiments. In comparison to FIG. 2A, in this example, the current time 2203 is presented in an upper portion of the display area 2201, while the expiration moment 2205 is presented in a lower portion of the display area 2201.

Referring to FIG. 3E, one example of a screen display 3020 for a calendar application incorporating aspects of the disclosed embodiments is illustrated. As shown in FIG. 3E, a portion 3022 of a day's calendar sheet is presented on the screen 3020. In this example, the starting moment of a meeting has already been set. The meeting is scheduled to start at 12:00 o'clock, which is indicated by the upper border of the appointment or meeting rectangle 3021, which is at the height of the 12h-line in the left-hand scale of hours. In order to adjust the end moment of the meeting, gesture 3024 is input. Gesture 3024 has a start point 3024a in the hours' portion 3023a of the slidepad area and an end point 3024b. When making the time adjustments, the resulting time that is going to be reserved for the appointment, meeting or event, can be displayed on the screen as an emphasized rectangle 3021 at the same time when the end time is being set with a sliding gesture 3024, on the screen 3020. In this way the resulting time that is reserved for an appointment, meeting or event can be visualized in a pictorial, quick-to-see way, which helps in figuring out, how the set time relates to the existing appointments, meetings and events that have been saved to the calendar application of the device, for example.

In this example, a “set end of meeting” feature can be activated that allows for using a gesture to set an end time for the meeting. In the same way as in the examples of FIGS. 2A . . . 3D, the time setting can be made with a sliding gesture, typically with the thumb of the hand that is holding the device. This means that the time setting of most appointments can be made with a single hand. Although in FIG. 3E the starting point and the increment points of the gesture 3024 match with the lines of 12h, 13h, 14h and 15h, they need not match; the gesture can be made anywhere in the display area 3020. Adjustments which use the default increment unit of one hour can be made with a sliding gesture that at least starts on the left hand portion 3023a of the display 3020. Adjustments which use the default increment unit of 10 minutes can be made with a gesture that at least starts on the right hand portion 3023b of the display 3020.

As the gesture 3024 is being made or input, sensory feedback is provided at each increment point 3025a, 3025b, 3025c, where each increment in this example adds one-hour to the end time 3025 because the start point 3024a of gesture 3024 is in the hours' adjust area. The gesture 3024 is in a substantially downward direction and reaches three increment points, 3025a, 3025b, 3025c Thus, the time setting is increased by three-hours to 15:00.

In one embodiment, as shown in FIG. 3E, an area 3026 can be provided that allows for confirmation of the time adjustment provided by the gesture 3024. In this example, a message 3027 is provided that asks if the end time of the event is to be set to 15:00. A “Yes” selection in input area 3026a and a “Cancel” selection in input area 3026b are provided that allows for a suitable confirmation to be provided.

FIG. 3F illustrates an example where the slidepad area 3239 is divided to four columns 3201a-3201d, in which are respectively located the 10 hours', 1 hour's, 10 minutes' and 1 minute's digits of the resulting adjusted time. Each of the columns 3201a-3201d has a pre-defined increment value, which matches with the displayed digit in each column, which are for example, 10 hours, 1 hour, 10 minutes, and 1 minute, respectively. The value of the time increment unit of a time setting gesture depends on the column in which the sliding gesture is started. In the example of FIG. 3F, sliding gesture 3210 starts in column 3201b, corresponding to the 1 hour's column with an increment of one hour. The first vertical portion 3202 of the gesture 3210 reaches the increment point 3203a, at which one hour is added to the adjusted time, and changes the initial time of 08:56 to 09:56. With the next, substantially horizontal portion 3204 of gesture 3210, which goes from the left to the right, the increment value is decreased from the initial increment value of 1 hour to the value of 10 minutes at point 3203b, and then to 1 minute at point 3203c. The next portion 3205 of the gesture 3210 is substantially vertical, and reaches two increment points 3203d and 3203e, at each of which is added one minute to the adjusted time. In this way the resulting adjusted time is changed to 09:58. When making this gesture 3210, the user only has to pay attention to the starting point 3210a of the sliding gesture 3210. The time adjustments corresponding to the gesture 3210 are independent of what columns the route of the sliding gesture goes through; only the starting point of the gesture and the number of increment changes matter.

In this example, as in other applications, the increment value can be changed by more than one step with a sufficiently long horizontal sliding movement, which generates more than one feedback signal.

Although the examples described herein are generally with respect to time units such as minutes and hours, in alternate embodiments other time units can be used. For example, in a calendar application, with a substantially horizontal sliding movement it is possible to change the increment value from 1 day to 1 month, which in this example could be a horizontal sliding movement from the right to the left and long enough to reach two increment points. At the first increment point, the increment value is changed from 1 day to 1 week, and at the second increment point the increment value is changed to 1 month. To visualize that change, the calendar view in the screen can change accordingly, e.g. from the portion 3022 of FIG. 3E, to the week's view, and next to the month's view of the calendar.

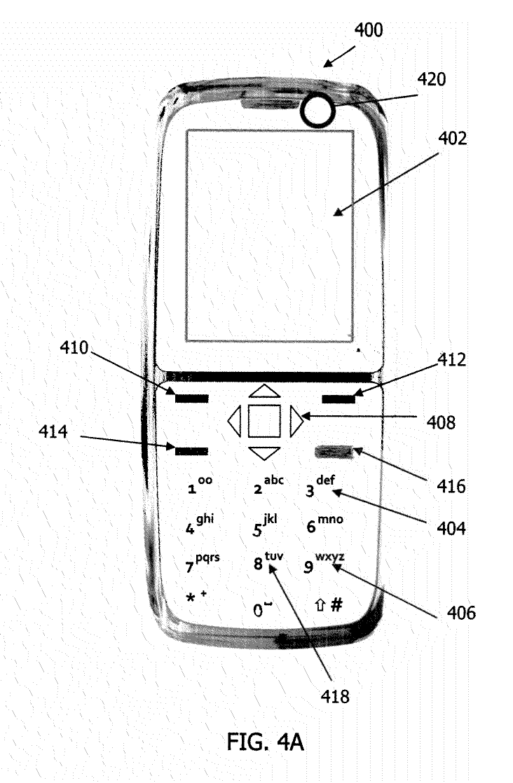

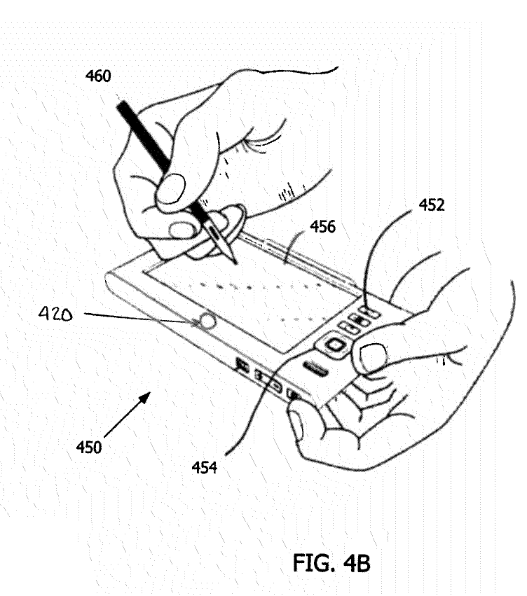

Some examples of devices on which aspects of the disclosed embodiments can be practised are illustrated with respect to FIGS. 4A-4B. The devices are merely exemplary and are not intended to encompass all possible devices or all aspects of devices on which the disclosed embodiments can be practised. The aspects of the disclosed embodiments can rely on very basic capabilities of devices and their user interface. Buttons or key inputs can be used for selecting the various selection criteria and links, and a scroll function can be used to move to and to select item(s).

As shown in FIG. 4A, in one embodiment, the device 400 has a display area 402 and an input area 404. The input area 404 is generally in the form of a keypad. In one embodiment the input area 404 is touch sensitive. As noted herein, in one embodiment, the display area 402 can also have touch sensitive characteristics. Although the display 402 of FIG. 4A is shown being integral to the device 400, in alternate embodiments, the display 402 may be a peripheral display connected or coupled to the device 400.

In one embodiment, the keypad 406, in the form of soft keys, may include any suitable user input functions such as, for example, a multi-function/scroll key 408, soft keys 410, 412, call key 414, end key 416 and alphanumeric keys 418. In one embodiment, referring to FIG. 4B., the touch screen area 456 of device 450 can also present secondary functions, other than a keypad, using changing graphics. As shown in FIG. 4B, in one embodiment, a pointing device, such as for example, a stylus 460, pen or simply the user's finger, may be used with the touch sensitive display 456. In alternate embodiments any suitable pointing device may be used. In other alternate embodiments, the display may be any suitable display, such as for example a flat display 456 that is typically made of a liquid crystal display (LCD) with optional back lighting, such as a thin film transistor (TFT) matrix capable of displaying color images.

The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to include that a user, or pointing device, only needs to be within the proximity of the device to carry out the desired function.

Similarly, the scope of the intended devices is not limited to single touch or contact devices. Multi-touch devices, where contact by one or more fingers or other pointing devices can navigate on and about the screen, are also intended to be encompassed by the disclosed embodiments. Non-touch devices are also intended to be encompassed by the disclosed embodiments. Non-touch devices include, but are not limited to, devices without touch or proximity screens, where navigation on the display and menus of the various applications is performed through, for example, keys 110 of the system (illustrated in FIG. 1) or through voice commands via voice recognition features of the system.

In one embodiment, the device 400 can include an image capture device such as a camera 420 as a further input device. The device 400 may also include other suitable features such as, for example a loudspeaker, tactile feedback devices or connectivity port. The mobile communications device may have a processor or other suitable computer program product connected or coupled to the display for processing user inputs and displaying information on the display 402 of device 400 or touch sensitive area 456 of device 450. A computer readable storage device, such as a memory may be connected to the processor for storing any suitable information, data, settings and/or applications associated with each of the mobile communications devices 400 and 456.

Although the above embodiments are described as being implemented on and with a mobile communication device, it will be understood that the disclosed embodiments can be practised on any suitable device incorporating a processor, memory and supporting software or hardware. For example, the disclosed embodiments can be implemented on various types of music, gaming, electronic book and multimedia devices. In one embodiment, the device 120 of FIG. 1 may be for example, a personal digital assistant (PDA) style device 450 illustrated in FIG. 4B. The personal digital assistant 450 may have a keypad 452, cursor control 454, a touch screen display 456, and a pointing device 460 for use on the touch screen display 456. In one embodiment, the touch screen display 456 can include a QWERTY keyboard. In still other alternate embodiments, the device may be a personal computer, a tablet computer, touch pad device, Internet tablet, a laptop or desktop computer, a mobile terminal, a cellular/mobile phone, a multimedia device, a personal communicator, an electronic book reader, a television set top box, a digital video/versatile disk (DVD) or high definition player or any other suitable device capable of containing for example a display and supported electronics such as a processor(s) and memory(s). In one embodiment, these devices will be Internet enabled and include GPS and map capabilities and functions.

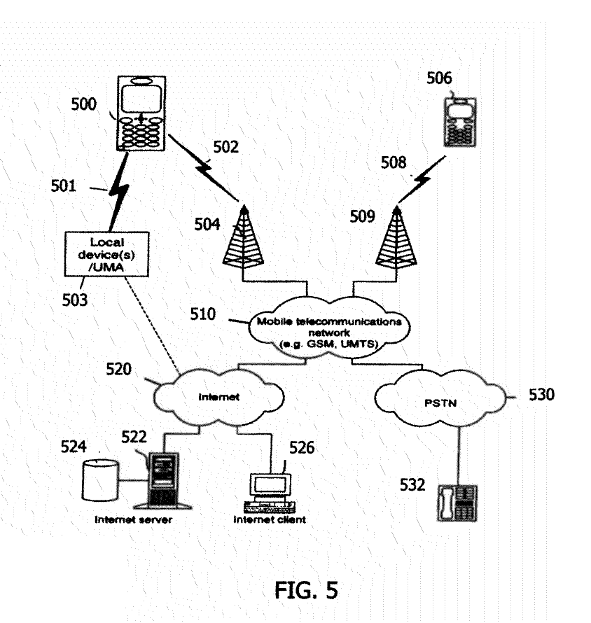

In the embodiment where the device 400 or 450 comprises a mobile communications device, the device can be adapted for communication in a telecommunication system, such as that shown in FIG. 5. In such a system, various telecommunications services such as cellular voice calls, worldwide web/wireless application protocol (www/wap) browsing, cellular video calls, data calls, facsimile transmissions, data transmissions, music transmissions, multimedia transmissions, still image transmission, video transmissions, electronic message transmissions and electronic commerce may be performed between the mobile terminal 500 and other devices, such as another mobile terminal 506, a line telephone 532, a personal computer (Internet client) 526 and/or an internet server 522.

It is to be noted that for different embodiments of the mobile device or terminal 500, and in different situations, some of the telecommunications services indicated above may or may not be available. The aspects of the disclosed embodiments are not limited to any particular set of services or communication, protocol or language in this respect.

The mobile terminals 500, 506 may be connected to a mobile telecommunications network 510 through radio frequency (RF) links 502, 508 via base stations 504, 509. The mobile telecommunications network 510 may be in compliance with any commercially available mobile telecommunications standard such as for example the global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 510 may be operatively connected to a wide-area network 520, which may be the Internet or a part thereof. An Internet server 522 has data storage 524 and is connected to the wide area network 520. The server 522 may host a worldwide web/wireless application protocol server capable of serving worldwide web/wireless application protocol content to the mobile terminal 500. The mobile terminal 500 can also be coupled to the Internet 520. In one embodiment, the mobile terminal 500 can be coupled to the Internet 520 via a wired or wireless link, such as a Universal Serial Bus (USB) or Bluetooth™ connection, for example.

A public switched telephone network (PSTN) 530 may be connected to the mobile telecommunications network 510 in a familiar manner. Various telephone terminals, including the stationary telephone 532, may be connected to the public switched telephone network 530.

The mobile terminal 500 is also capable of communicating locally via a local link 501 to one or more local devices 503. The local links 501 may be any suitable type of link or piconet with a limited range, such as for example Bluetooth™, a USB link, a wireless Universal Serial Bus (WUSB) link, an IEEE 802.11 wireless local area network (WLAN) link, an RS-232 serial link, etc. The local devices 503 can, for example, be various sensors that can communicate measurement values or other signals to the mobile terminal 500 over the local link 501. The above examples are not intended to be limiting and any suitable type of link or short range communication protocol may be utilized. The local devices 503 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 500 may thus have multi-radio capability for connecting wirelessly using mobile communications network 510, wireless local area network or both. Communication with the mobile telecommunications network 510 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the communication module 134 of FIG. 1 is configured to interact with, and communicate with, the system described with respect to FIG. 5.

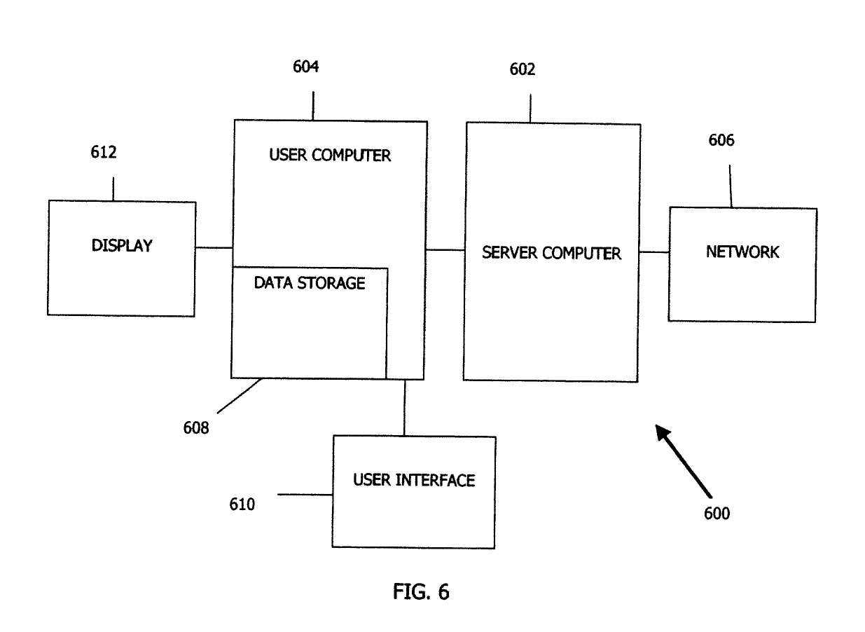

The disclosed embodiments may also include software and computer programs incorporating the process steps and instructions described above. In one embodiment, the programs incorporating the process steps described herein can be stored on or in a computer program product and executed in one or more computers. FIG. 6 is a block diagram of one embodiment of a typical apparatus 600 incorporating features that may be used to practise aspects of the invention. The apparatus 600 can include computer readable program code means embodied or stored on a computer readable storage medium for carrying out and executing the process steps described herein. In one embodiment the computer readable program code is stored in a memory(s) of the device. In alternate embodiments the computer readable program code can be stored in memory or other storage medium that is external to, or remote from, the apparatus 600. The memory can be direct coupled or wireless coupled to the apparatus 600. As shown, a computer system 602 may be linked to another computer system 604, such that the computers 602 and 604 are capable of sending information to each other and receiving information from each other. In one embodiment, computer system 602 could include a server computer adapted to communicate with a network 606. Alternatively, where only one computer system is used, such as computer 604, computer 604 will be configured to communicate with and interact with the network 606. Computer systems 602 and 604 can be linked together in any conventional manner including, for example, a modem, wireless, hard wire connection, or fiber optic link. Generally, information can be made available to both computer systems 602 and 604 using a communication protocol typically sent over a communication channel or other suitable connection or line, communication channel or link. In one embodiment, the communication channel comprises a suitable broad-band communication channel. Computers 602 and 604 are generally adapted to utilize program storage devices embodying machine-readable program source code, which is configured to cause the computers 602 and 604 to perform the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks and semiconductor materials and chips.

Computer systems 602 and 604 may also include a microprocessor(s) for executing stored programs. Computer 602 may include a data storage device 608 on its program storage device for the storage of information and data. The computer program or software incorporating the processes and method steps incorporating aspects of the disclosed embodiments may be stored in one or more computers 602 and 604 on an otherwise conventional program storage device. In one embodiment, computers 602 and 604 may include a user interface 610, and/or a display interface 612 from which aspects of the invention can be accessed. The user interface 610 and the display interface 612, which in one embodiment can comprise a single interface, can be adapted to allow the input of queries and commands to the system, as well as present the results of the commands and queries, as described with reference to FIG. 1, for example.

The aspects of the disclosed embodiments provide for adjusting a timed profile of a mobile style device in an “eyes-free” operation. The length of time that a timed profile of the device will last (from the current time to the expiration moment) can be set by providing a sliding movement or gesture input, typically with a finger, thumb or a pointing instrument (stylus). The length of the sliding movement can be felt as haptic feedback signals (e.g. “kickbacks”) or heard as short tones (“ticks”) that are given at pre-defined distances (“intervals”) along the length of the sliding movement. The sliding movement can generally be made anywhere within the slidepad area. A start point of a particular sliding movement is used to determine the time value increment corresponding to the sliding movement of the gesture. For time adjustments which use one hour as the default increment unit, in one embodiment the gesture starts on a left-side portion of the slidepad area, which generally corresponds to the hour digits' area of a clock. For time adjustments which use 10 minutes as the default increment unit, the gesture is supposed to start on the right-side portion of the slidepad area. The hour and minute adjustment area locations can generally correspond to the sides of a digital clock or similar digital timing device where such digits are located.

The length of the sliding gestures of the disclosed embodiments does not need to be exact. What affects the resulting time adjustment is not the exact length of the sliding gesture, but the number incremental feedback signals generated along the route of the gesture. The incremental feedback allows the user to sense each incremental change, whether the time increment is being changed, and an amount or degree of the change. Generally, sliding in one direction results in an increase in time, while sliding in the opposite direction results in a decrease in time.

In one embodiment, an error signal can be provided if the sliding movements are not within the allowed direction tolerances. For the error signals, a certain tolerance area can be arranged. For example, if the tolerance of the vertical directions is ±45 degrees, and the tolerance of the horizontal directions is ±30 degrees, the error signal is generated if the direction of the sliding movement is between 30 and 45 degrees from the horizontal direction. The regular feedback signals of each allowed sliding direction, the vertical (increasing and decreasing) directions, and the horizontal (increment-increasing and increment-decreasing) directions, as well as the error signal can be distinguished from each other. Different signal patterns can be used, such as different tone pitches as well as predefined rhythms and number of the tactile and aural signals.

Furthermore, the route of the sliding gesture of the disclosed embodiments does not need to be a straight line. Deviations are allowed within a range of direction tolerances (e.g. ±45 degrees for the vertical sliding gestures, and ±30 degrees for the horizontal sliding gestures). This makes it possible to use slightly curved gestures, which match with the natural movements of the thumb of the same hand that holds the portable device. The Sliding Input Detection/Determination Module (140) of the device makes real-time measurements and calculations of the length and direction of the sliding movement, as well as its deviations from the vertical or horizontal direction (in relation to the edges of the slidepad area), taking into account the latest average of certain lengths of the sliding movement (the latest 3 millimeters, for example), along the route of the gesture.

The aspects of the disclosed embodiments are generally configured to allow one-handed operation. The wide tolerances of the sliding directions mean that the natural thumb movements of either the left or right hand can be used. For example, the substantially vertical sliding gestures can be made with the thumb of the same (left or right) hand that holds the device.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
detecting a signal corresponding to a sliding input on a touch sensitive area of a device, the sliding input being for a time setting adjustment;
determining a time unit corresponding to a start point of the sliding input; and
if the signal indicates that the sliding input is substantially in a first direction increasing a time setting of the corresponding time unit by a pre-defined increment; and
if the signal indicates that the sliding input is substantially in a second direction decreasing the time setting of the corresponding time unit by a pre-defined increment.

2. The method of claim 1 wherein the first direction is substantially opposite to the second direction.

3. The method of claim 1 further comprising providing a sensory feedback signal indicating a change of the time setting by the pre-defined increment, as the sliding movement reaches or exceeds a pre-defined distance in either the first direction or the second direction.

4. The method of claim 1 further comprising:
adjusting an increment value of the corresponding time unit to a lesser increment value if it is detected that the sliding input is substantially in a third direction; and
adjusting an increment value of the corresponding time unit to a larger increment unit if it is detected that the sliding input is substantially in a fourth direction, wherein the third direction is substantially opposite to the fourth direction, and an axis corresponding to the third and fourth direction is different than an axis corresponding to the first and second direction.

5. The method of claim 4 wherein the axis corresponding to the first and second direction is vertical and the axis corresponding to the third and fourth direction is horizontal.

6. The method of claim 4 further providing a sensory feedback signal indicating a change of an increment unit value, as the sliding movement in either the third direction or the fourth direction reaches or exceeds a pre-defined distance.

7. The method of claim 1 wherein the time setting area comprises at least an hours' increment adjustment area and a minutes' increment adjustment area.

8. The method of claim 1 further comprising adjusting the time setting with an hours' increment value when the start point of the sliding input is on a left side portion of the touch sensitive area and adjusting the time setting with a minutes' increment value when the start point of the sliding input is on the right side portion of the touch sensitive area.

9. The method of claim 1 further comprising:
detecting at least one time increment point on a route of the sliding input;
detecting an end of the sliding input; and
adjusting the time setting to a value that is a number of time increment points along the route of the sliding input multiplied by an increment value of each time increment unit.

10. The method of claim 1 further comprising detecting a signal corresponding to a second sliding input in the touch sensitive area after an end point of the sliding input is detected, and if the second sliding input is detected within a pre-defined time period, continuing with the time setting adjustment.

11. The method of claim 1 further comprising detecting an end of a movement in the first or second direction of the sliding input, detecting a start point of another sliding input, and continuing the time-setting operation of the sliding input with the another sliding input.

12. An apparatus comprising:
at least one processor; and
at least one memory including computer program code;
the at least one memory and the computer program code configured to, with the at least one processor, cause the apparatus at least to perform:
detecting a signal corresponding to a sliding input on a touch sensitive area of a device, the sliding input being for a time setting adjustment;
determining a time unit corresponding to a start point of the sliding input; and
if the signal indicates that the sliding input is substantially in a first direction increasing a time setting of the corresponding time unit by a pre-defined increment; and
if the signal indicates that the sliding input is substantially in a second direction, decreasing the time setting of the corresponding time unit by a pre-defined increment.

13. The apparatus of claim 12 wherein the first direction is substantially opposite to the second direction.

14. The apparatus of claim 12 wherein the apparatus is further configured to perform adjusting an increment value of the corresponding time unit to a lesser increment value if it is detected that the sliding input is substantially in a third direction; and adjusting an increment value of the corresponding time unit to a larger increment unit if it is detected that the sliding input is substantially in a fourth direction, wherein the third direction is substantially opposite to the fourth direction, and an axis corresponding to the third and fourth direction is different than an axis corresponding to the first and second direction.

15. The apparatus of claim 14, wherein the apparatus is further configured to perform providing a sensory feedback signal indicating a change of the time setting by the pre-defined increment, as the sliding movement in either the first direction or the second direction reaches or exceeds a pre-defined length; and providing a sensory feedback signal indicating a change of an increment unit value as the sliding movement in either the third direction or the fourth direction reaches or exceeds a pre-defined length.

16. The apparatus of claim 12 wherein the apparatus is further configured to perform adjusting the time setting with an hours' increment value when the start point of the sliding input is on a left side portion of the touch sensitive area and adjusting the time setting with a minutes' increment value when the start point of the sliding input is on the right side portion of the touch sensitive area.

17. The apparatus of claim 12 wherein the apparatus is a mobile device.

18. A computer program product comprising a computer-readable medium bearing computer code embodied therein for use with a computer, the computer program code comprising:
code for detecting a signal corresponding to a sliding input on a touch sensitive area of a device, the sliding input being for a time setting adjustment;
code for determining a time unit corresponding to a start point of the sliding input; and
if the signal indicates that the sliding input is substantially in a first direction code for increasing a time setting of the corresponding time unit by a pre-defined increment; and
if the signal indicates that the sliding input is substantially in a second direction code for decreasing the time setting of the corresponding time unit by a pre-defined increment.

19. The computer program product of claim 18, the computer program code further comprising code for adjusting an increment value of the corresponding time unit to a lesser increment unit if it is detected that the sliding input is substantially in a third direction in the time setting area; and code for adjusting an increment value of the corresponding time unit to a larger increment unit if it detected that the sliding input is substantially in a fourth direction in the time setting area, wherein the third direction is substantially opposite to the fourth direction, and an axis corresponding to the third and fourth directions is different than an axis corresponding to the first and second directions.

20. The computer program product of claim 19, the computer program code further comprising code for providing a sensory feedback signal indicating a change of the time setting by the pre-defined increment, as the sliding movement reaches or exceeds a pre-defined length in either the first direction or the second direction; and code for providing a sensory feedback signal indicating a change of an increment unit value, as the sliding movement reaches or exceeds a pre-defined length in either the third direction or the fourth direction.
